(19) United States
(12) Patent Application Publication
(10) Pub. No.: US 2026/0370133 A1
(43) Pub. Date: Nov. 19, 2026

(54) STARTUP SCHEME FOR HIGH-VOLTAGE BOOST POWER STAGE

(71) Applicant: Cirrus Logic International Semiconductor Ltd., Edinburgh (GB)

(72) Inventors: Axel THOMSEN, Austin, TX (US); Ravi K. KUMMARAGUNTLA, Austin, TX (US); Yongjie CHENG, Austin, TX (US)

(73) Assignee: Cirrus Logic International Semiconductor Ltd., Edinburgh (GB)

(21) Appl. No.: 19/209,067

(22) Filed: May 15, 2025

(51) Int. Cl. H02M 1/36; H02M 3/07; H02M 3/158

(52) U.S. Cl. CPC H02M 1/36; H02M 3/07; H02M 3/158

(57) ABSTRACT

A system may include a boost converter configured to receive an input voltage to generate an output voltage significantly larger than the input voltage and a startup circuit comprising a first charge pump configured to generate at its output a first pumped voltage equal to the input voltage plus a reference voltage, a second charge pump configured to generate at its output a second pumped voltage equal to the input voltage plus the reference voltage, and a bridge circuit coupled at its input to the output of the first charge pump and coupled at its output to the output of the second charge pump and configured to, during a startup phase for the boost converter, charge its output to a level significantly higher than the input voltage in order to enable effective startup of the boost converter.

### FIELD OF DISCLOSURE

The present disclosure relates in general to circuits for electronic devices, including without limitation personal audio devices such as wireless telephones and media players, and more specifically, a startup scheme in a system comprising a high-voltage boost power stage.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter), oftentimes as part of a power management integrated circuit (PMIC) or a battery charger.

For a boost converter with a large boost ratio, startup of the boost converter presents challenges. To support a high boost output voltage, a power stage may need to use high-voltage devices, which may have higher threshold voltages (e.g., greater than 1.5V). For large boost ratios, the input voltage to the boost converter may be small, sometimes as small as 3V. When the boost converter is enabled, the output of the boost converter may be below the input voltage, meaning the output may need to be charged to the input voltage before boosting can begin. In order to start up the output of the boost to charge it to the input voltage, a supply voltage greater than the input voltage may be needed (e.g., may need to create a 5V supply voltage when the input voltage is 3V). In addition, a circuit generating such supply voltage needs to be able to tolerate the maximum boost output in normal operation (e.g., tolerate 50V when the output voltage of the boost converter is 45V).

### SUMMARY

In accordance with the teachings of the present disclosure, one or more disadvantages and problems associated with operation of power converters may be reduced or eliminated.

In accordance with embodiments of the present disclosure, a system may include a boost converter configured to receive an input voltage to generate an output voltage significantly larger than the input voltage and a startup circuit comprising a first charge pump configured to generate at its output a first pumped voltage equal to the input voltage plus a reference voltage, a second charge pump configured to generate at its output a second pumped voltage equal to the input voltage plus the reference voltage, and a bridge circuit coupled at its input to the output of the first charge pump and coupled at its output to the output of the second charge pump and configured to, during a startup phase for the boost converter, charge its output to a level significantly higher than the input voltage in order to enable effective startup of the boost converter.

In accordance with these and other embodiments of the present disclosure, a method may include, in a system having a boost converter configured to receive an input voltage to generate an output voltage significantly larger than the input voltage, generating, with a first charge pump of a startup circuit, a first pumped voltage equal to the input voltage plus a reference voltage at an output of the first charge pump. The method may also include generating, with a second charge pump of the startup circuit, a second pumped voltage equal to the input plus the reference voltage at an output of the second charge pump. The method may further include charging during a startup phase for the boost converter, with a bridge circuit coupled at its input to the output of the first charge pump and coupled at its output to the output of the second charge pump, an output of the bridge circuit to a level significantly higher than the input voltage in order to enable effective startup of the boost converter.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a circuit diagram of selected components of an example system comprising a boost converter, in accordance with embodiments of the present disclosure;

FIG. 2 illustrates a circuit diagram of selected components of an example system comprising a two-level boost converter, in accordance with embodiments of the present disclosure;

FIG. 3 illustrates a circuit diagram of selected components of an example system comprising a three-level boost converter, in accordance with embodiments of the present disclosure; and

FIG. 4 illustrates a circuit diagram of selected components of an example bridge circuit in accordance with embodiments of the present disclosure.

### DETAILED DESCRIPTION

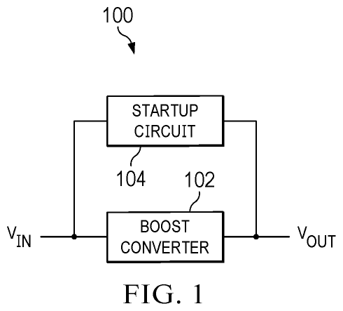

FIG. 1 illustrates a circuit diagram of selected components of an example system 100 comprising a boost converter 102, in accordance with embodiments of the present disclosure. As shown in FIG. 1, in addition to boost converter 102, system 100 may include a startup circuit 104.

Boost converter 102 may comprise any system, device, or apparatus configured to receive a direct current (DC) input voltage V_{IN} at its input terminal and generate a significantly higher DC output voltage V_{OUT} at its output terminal. In some embodiments, boost converter 102 may comprise an inductor-based switching boost converter or a capacitor-based switching boost converter. In inductor-based switching boost converter embodiments, boost converter 102 may comprise a traditional two-level boost converter, or may comprise a multi-level (e.g., three-level or higher) boost converter.

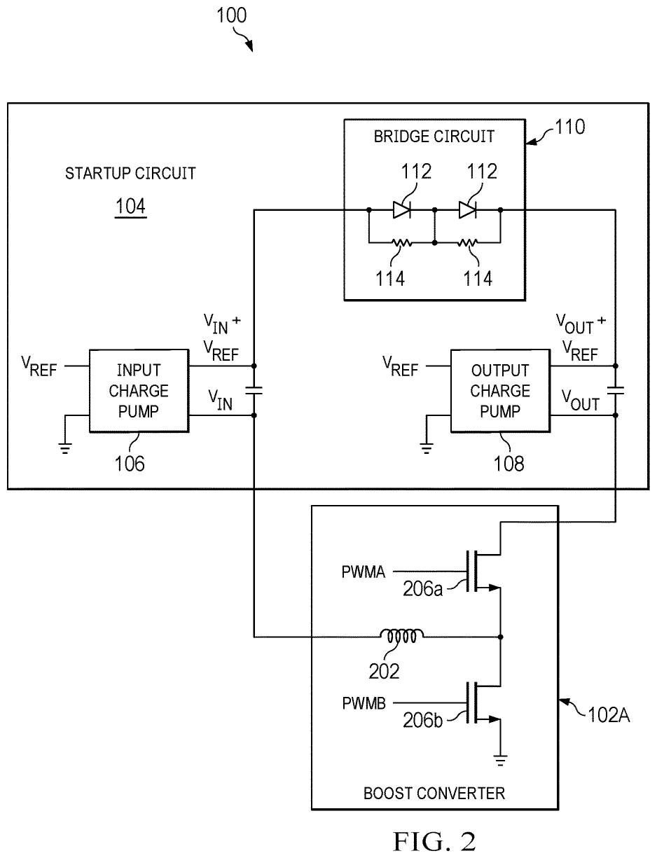

Startup circuit 104 may comprise any system, device, or apparatus configured to pre-charge output voltage V_{OUT} to a voltage level equal or higher to input voltage V_{IN}, to enable effective startup of boost converter 102. As shown in FIG. 2, startup circuit 104 may include an input charge pump 106, an output charge pump 108, and a bridge circuit 110 coupled between input charge pump 106 and output charge pump 108.

Input charge pump 106 may comprise any system, device, or apparatus configured to receive input voltage V_{IN}, and from input voltage V_{IN}, generate a pumped voltage V_{IN} +V_{REF} wherein reference voltage V_{REF} is a gate driver reference voltage. Such gate driver reference voltage may be a gate-to-source voltage necessary to enable (e.g., turn on, activate, close) switches of boost converter 102. In some embodiments, input charge pump 106 may comprise a switched-capacitor charge pump.

Output charge pump 108 may comprise any system, device, or apparatus configured to receive input voltage V_{OUT}, and from output voltage V_{OUT}, generate a pumped voltage V_{OUT}+V_{REF}. In some embodiments, output charge pump 108 may comprise a switched-capacitor charge pump.

Bridge circuit 110 may be coupled between the respective outputs of input charge pump 106 and output charge pump 108 (e.g., between the voltage nodes of pumped voltage V_{IN}+V_{REF} and pumped voltage V_{OUT}+V_{REF}). As shown in FIG. 2, in some embodiments, bridge circuit 110 may comprise one or more diodes 112 in series and arranged such that, when the one or more diodes 112 are forward biased, V_{OUT}+V_{REF}<V_{IN}+V_{REF} (i.e., the output voltage of bridge circuit 110 is lesser than the input voltage of the bridge circuit, with such difference being approximately equal to the cumulative diode voltage drops of the one or more diodes 112). Bridge circuit 110 may also include a resistor divider comprising one or more resistors 114, each resistor 114 in parallel with a corresponding diode 112.

During startup, bridge circuit 110 may charge its output to a level significantly higher than input voltage V_{IN}, to enable effective startup of boost converter 102. Using illustrative but non-limiting example voltage levels, input voltage V_{IN} may be 3V and reference voltage V_{REF} may be 3V, meaning bridge circuit 110 receives pumped voltage V_{IN}+V_{REF} =6V at its input. In embodiments in which bridge circuit 110 comprises two series diodes 112, and assuming diode voltage drop V_{D} of 0.8V when diodes 112 are forward-biased, bridge circuit 110 may generate a voltage of V_{IN}+V_{REF}−2 V_{D}=4.4V at its output, wherein such output is equal to pumped voltage V_{OUT}+V_{REF}.

Thus, bridge circuit 110 may generate a voltage high enough to enable switches of boost converter 102 (e.g., switch 206a in FIG. 2). To illustrate, if V_{OUT}=0V and V_{REF}=3V, then V_{OUT}+V_{REF} =3V which may not be sufficient to enable switch 206a because V_{IN} itself is 3V. However, with bridge circuit 110, the output of the output charge pump 108 may go to 4.4V. Thus, the gate voltage of switch 206 a, which is generated from output charge pump 108, may go to 4.4V while its source voltage is at 3V, providing sufficient gate-to-source voltage to enable switch 206a.

After startup, and with boost converter 102 in steady-state operation, output voltage V_{OUT} may be much greater than input voltage V_{IN}, such that diodes 112 are no longer forward biased and are thus inactive, cutting the electrical path between the outputs of input charge pump 106 and output charge pump 108. Resistances of resistors 114 may serve to divide the reverse bias across the one or more diodes 112 to maintain the reverse bias voltage across each diode 112 below its breakdown voltage. Further, to minimize current flow from the output of bridge circuit 110 to its input, resistances of resistors 114 may be selected to have very high values (e.g., large enough values to have insignificant power dissipation, such as 1 MΩ).

As mentioned above, boost converter 102 may be implemented using any suitable topology. For example, FIG. 2 illustrates a circuit diagram of selected components of system 100 wherein boost converter 102 is implemented as a two-level boost converter 102A, in accordance with embodiments of the present disclosure. As shown in FIG. 2, two-level boost converter 102A may include a power inductor 202 and switches 206a and 206b (controlled by control signals PWMA and PWMB, respectively) coupled to each other and to input voltage V_{IN} and output voltage V_{OUT} as shown.

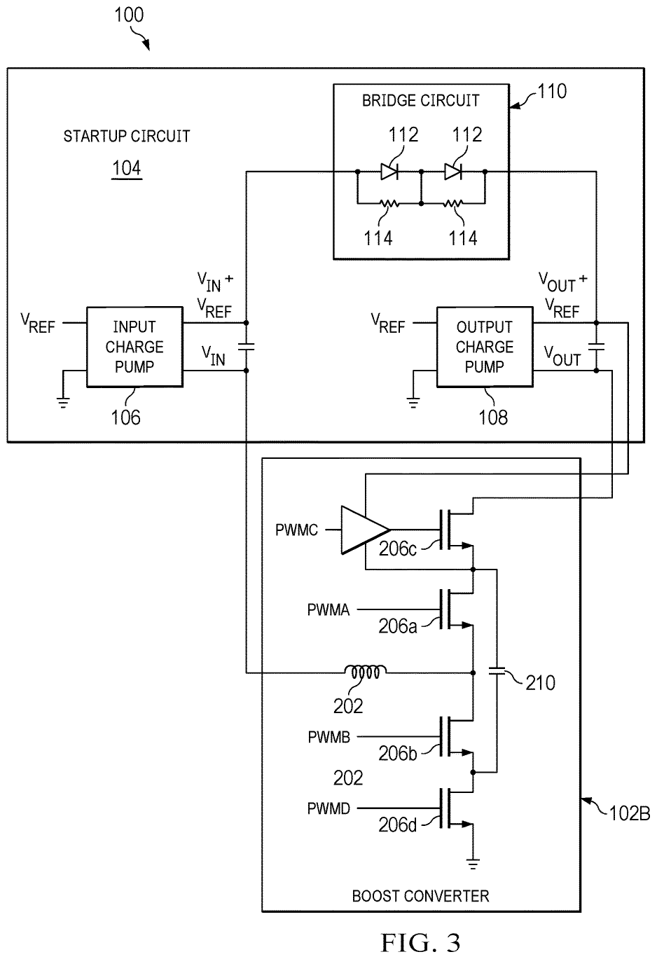

As another example, FIG. 3 illustrates a circuit diagram of selected components of system 100 wherein boost converter 102 is implemented as a three-level boost converter 102B, in accordance with embodiments of the present disclosure. As shown in FIG. 3, three-level boost converter 102B may include a power inductor 202, switches 206a, 206b, 206c, and 206d (controlled by control signals PWMA, PWMB, PWMC, and PWMD respectively), and a flying capacitor 210, coupled to each other and to input voltage V_{IN} and output voltage V_{OUT} as shown.

Although FIGS. 2 and 3 depict embodiments of two-level boost converter 102A and three-level boost converter 102B, respectively, it is understood that boost converter 102 may be implemented using any suitable n-level boost converter, wherein n is an integer 2 or greater.

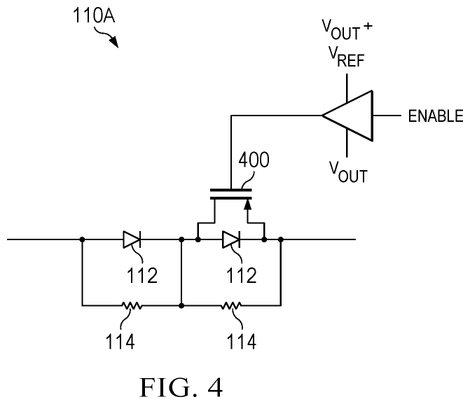

Further, although bridge circuit 110 is shown in FIGS. 1-3 as two series diodes 112 each in parallel with a respective resistor 114, other topologies of bridge circuit 110 are also possible. For example, in some embodiments, a resistor divider having resistors 114 may not be present. As another example, in these and other embodiments, bridge circuit 110 may comprise only a single diode 112. As a further example, as shown in FIG. 4, which depicts an example bridge circuit 110A, in some embodiments, one or more diodes 112 may be integral to a switch 400. In such embodiments, switch 400 may be enabled during startup of boost converter 102 and disabled during steady-state operation of boost converter 102 by way of a control signal ENABLE.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
a boost converter configured to receive an input voltage to generate an output voltage significantly larger than the input voltage; and
a startup circuit comprising:
a first charge pump configured to generate at its output a first pumped voltage equal to the input voltage plus a reference voltage;
a second charge pump configured to generate at its output a second pumped voltage equal to the input voltage plus the reference voltage; and
a bridge circuit coupled at its input to the output of the first charge pump and coupled at its output to the output of the second charge pump and configured to, during a startup phase for the boost converter, charge its output to a level significantly higher than the input voltage in order to enable effective startup of the boost converter.

2. The system of claim 1, wherein the bridge circuit comprises a diode coupled between the input of the bridge circuit and the output of the bridge circuit such that the diode conducts from the input of the bridge circuit and the output of the bridge circuit when forward biased.

3. The system of claim 1, wherein the bridge circuit comprises a plurality of series-coupled diodes coupled between the input of the bridge circuit and the output of the bridge circuit such that the diodes conduct from the input of the bridge circuit and the output of the bridge circuit when forward biased.

4. The system of claim 3, further comprising a resistor divider comprising a plurality of resistors, wherein each resistor of the plurality of resistors is parallel-coupled to a resistive diode of the plurality of series-coupled diodes.

5. The system of claim 3, wherein one of the plurality of series-coupled diodes is integral to a switch which is enabled or disabled during the startup phase.

6. The system of claim 1, wherein the boost converter is a two-level boost converter.

7. The system of claim 1, wherein the boost converter is a three-level boost converter.

8. The system of claim 1, wherein the boost converter is a multi-level boost converter.

9. A method comprising, in a system having a boost converter configured to receive an input voltage to generate an output voltage significantly larger than the input voltage:
generating, with a first charge pump of a startup circuit, a first pumped voltage equal to the input voltage plus a reference voltage at an output of the first charge pump;
generating, with a second charge pump of the startup circuit, a second pumped voltage equal to the input plus the reference voltage at an output of the second charge pump; and
charging during a startup phase for the boost converter, with a bridge circuit coupled at its input to the output of the first charge pump and coupled at its output to the output of the second charge pump, an output of the bridge circuit to a level significantly higher than the input voltage in order to enable effective startup of the boost converter.

10. The method of claim 9, wherein the bridge circuit comprises a diode coupled between the input of the bridge circuit and the output of the bridge circuit such that the diode conducts from the input of the bridge circuit and the output of the bridge circuit when forward biased.

11. The method of claim 9, wherein the bridge circuit comprises a plurality of series-coupled diodes coupled between the input of the bridge circuit and the output of the bridge circuit such that the diodes conduct from the input of the bridge circuit and the output of the bridge circuit when forward biased.

12. The method of claim 11, wherein the system further comprises a resistor divider comprising a plurality of resistors, wherein each resistor of the plurality of resistors is parallel-coupled to a resistive diode of the plurality of series-coupled diodes.

13. The method of claim 11, wherein one of the plurality of series-coupled diodes is integral to a switch which is enabled or disabled during the startup phase.

14. The method of claim 9, wherein the boost converter is a two-level boost converter.

15. The method of claim 9, wherein the boost converter is a three-level boost converter.

16. The method of claim 9, wherein the boost converter is a multi-level boost converter.
